(19) United States
(12) Patent Application Publication
(10) Pub. No.: US 2019/0128316 A1
(43) Pub. Date: May 2, 2019

(54) ROTOR UNIT AND ROTOR UNIT MANUFACTURING METHOD

(71) Applicant: Honda Motor Co., Ltd., Tokyo (JP)

(72) Inventor: Andrii Pydin, Wako-shi (JP)

(21) Appl. No.: 16/155,770

(22) Filed: Oct. 9, 2018

(30) Foreign Application Priority Data
Oct. 26, 2017 (JP) 2017-207522

(51) Int. Cl. F16C 3/02; F16H 57/00; F16H 57/021

(52) U.S. Cl. CPC F16C 3/023; F16H 57/0025; F16H 2057/02034; F16C 2361/61; F16C 2226/36; F16H 57/021

(57) ABSTRACT

A rotor unit including a rotating shaft extended in an axial direction along an axial line, a pair of bearings rotatably supporting the rotating shaft, and a pair of spacers arranged adjacent to each other between the pair of bearings and coaxially with the rotating shaft and formed in substantially cylindrical shapes to surround the rotating shaft. The pair of spacers include sloped faces inclined with respect to reference planes perpendicular to the axial line at one axial end, respectively, and the sloped faces is configured to abut to each other and be welded to each other in a state that a length between the other ends of the pair of spacers in the axial direction is extended by torque applied to the pair of spacers in opposite directions with each other around the axial line.

### CROSS-REFERENCE TO RELATED APPLICATION

This application is based upon and claims the benefit of priority from Japanese Patent Application No. 2017-207522 filed on Oct. 26, 2017, the content of which is incorporated herein by reference.

### BACKGROUND OF THE INVENTION

### Field of the Invention

This invention relates to a rotor unit capable of applying preload to bearings and a manufacturing method of the rotor unit.

### Description of the Related Art

In the course of assembling a rotor including a rotating shaft rotatably supported by bearings, a predetermined axial preload is generally applied to the bearings in order to improve runout accuracy and reduce vibration and noise of the rotating shaft. In this regard, a conventional structure is known wherein one case including a preinstalled rotating shaft is bolted to a mating case and the bolt fastening force is exerted to apply preload to a pair of bearings rotatably supporting the rotating shaft. Such a structure is described in Japanese Unexamined Patent Publication No. 2003-154866 (JP2003-154866A), for example.

However, in a case where the bolt fastening force acts not parallel but, for example, perpendicular to the rotating shaft, the bolt fastening force does not contribute to bearing preload and application of suitable preload to the bearings therefore becomes difficult.

### SUMMARY OF THE INVENTION

An aspect of the present invention is a rotor unit including: a rotating shaft extended in an axial direction along an axial line; a pair of bearings configured to rotatably support the rotating shaft; and a pair of spacers arranged adjacent to each other between the pair of bearings and coaxially with the rotating shaft and formed in substantially cylindrical shapes to surround the rotating shaft. The pair of spacers include first ends facing each other and second ends opposite to the first ends in the axial direction, respectively, the first ends include sloped faces inclined with respect to reference planes perpendicular to the axial line, and the sloped faces is configured to abut to each other and be welded to each other in a state that a length between the second ends of the pair of spacers in the axial direction is extended by torque applied to the pair of spacers in opposite directions with each other around the axial line.

Another aspect of the present invention is a manufacturing method of a rotor unit, including: arranging a pair of bearings along an axial line through an opening formed in a case inside the case; arranging a pair of spacers formed in substantially cylindrical shapes centered on the axial line and including sloped faces inclined with respect to reference planes perpendicular to the axial line, along the axial line through the opening between the pair of bearings in a state with the sloped faces abutting each other; inserting a rotating shaft along the axial line to inside the pair of bearings and inside the pair of spacers; applying torque to the pair of spacers in opposite directions with each other around the axial line to extend a length from one end to the other end of the pair of spacers in the axial direction; and welding the sloped faces of the pair of spacers to each other in a state with the length extended.

### BRIEF DESCRIPTION OF THE DRAWINGS

The objects, features, and advantages of the present invention will become clearer from the following description of embodiments in relation to the attached drawings, in which:

FIG. 1 is a cross-sectional diagram showing a developed view of overall configuration of a vehicle drive apparatus to which a rotor unit according to an embodiment of the present invention is applied, wherein a comparative example of the rotor unit is installed;

FIG. 2 is an enlarged cross-sectional diagram of main parts of the vehicle drive apparatus of FIG. 1;

FIG. 3 is a perspective diagram showing part of the vehicle drive apparatus of FIG. 1, viewed obliquely from above;

FIG. 4 is a side view showing an example of installation of the vehicle drive apparatus of FIG. 1 in the vehicle;

FIG. 5 is an exploded perspective view of components of the vehicle drive apparatus of FIG. 1;

FIG. 6 is an exploded perspective view of main parts of the vehicle drive apparatus including the rotor unit according to the embodiment of the present invention;

FIG. 7 is a perspective diagram showing a spacer incorporated in the rotor unit of FIG. 6;

FIG. 8 is diagram showing the spacer of FIG. 7 in planar developed state;

FIG. 9 is a perspective view showing the pair of spacers incorporated in the rotor unit of FIG. 6 in their used condition;

FIG. 10 is a perspective view showing a step of a manufacturing method of the rotor unit according to the embodiment of the present invention;

FIG. 11 is a perspective view showing a step following FIG. 10;

FIG. 12 is a perspective view showing a step following FIG. 11;

FIG. 13 is diagram schematically illustrating overall configuration of a bearing preloader according to an embodiment of the present invention; and

FIG. 14 is a side view of the pair of spacers in the rotor unit of FIG. 6, showing states before and after torque is applied to the spacers.

### DETAILED DESCRIPTION OF THE INVENTION

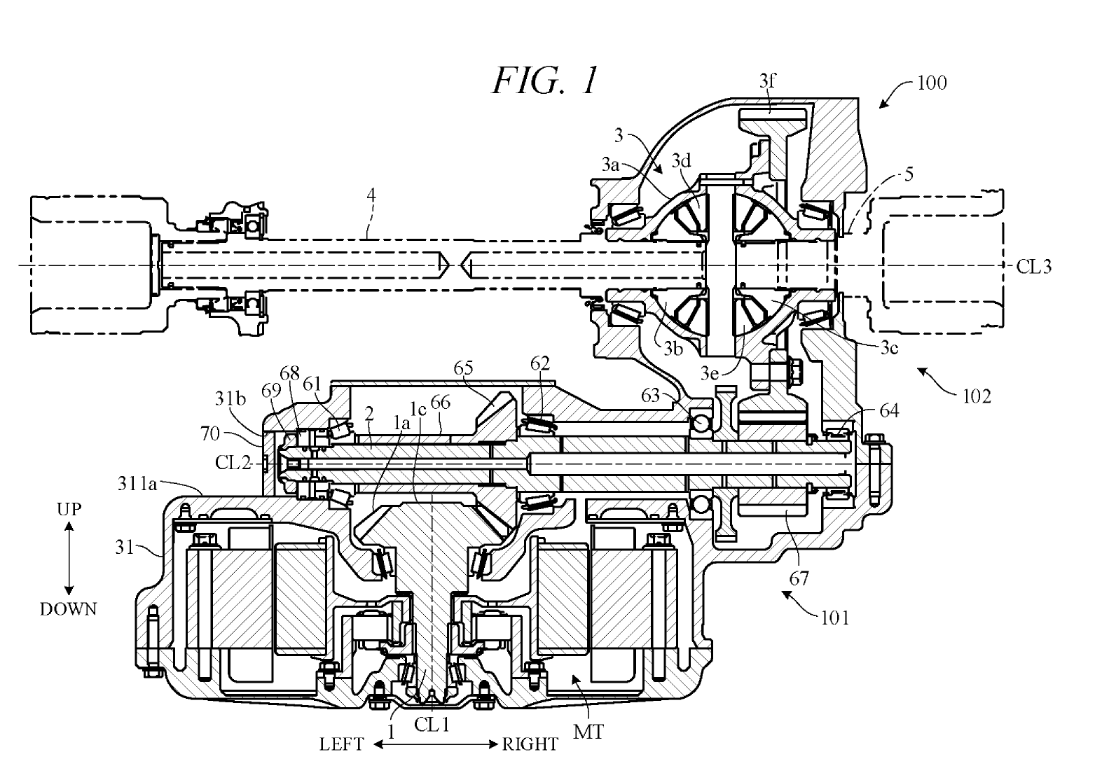

Hereinafter, an embodiment of the present invention is explained with reference to FIGS. 1 to 14. A rotor unit according to the embodiment of the present invention is applied to a vehicle drive apparatus, for example. Hereinafter, the configuration of the vehicle drive apparatus is explained using a comparative example of the rotor unit according to the embodiment.

FIG. 1 is a cross-sectional diagram showing a developed view of overall configuration of the vehicle drive apparatus 100, wherein the comparative example of the rotor unit is installed. The vehicle drive apparatus 100 includes an electric motor MT as an example of a dynamoelectric machine and is configured to output torque from the electric motor MT to driving wheels of a vehicle. Therefore, the vehicle drive apparatus 100 is mounted on an electric vehicle, hybrid vehicle or other vehicle having the electric motor MT as a drive (propulsion) power source. In FIG. 1, vehicle vertical (height) direction, i.e., up-down direction and lateral (width) direction, i.e., left-right direction are indicated by arrows.

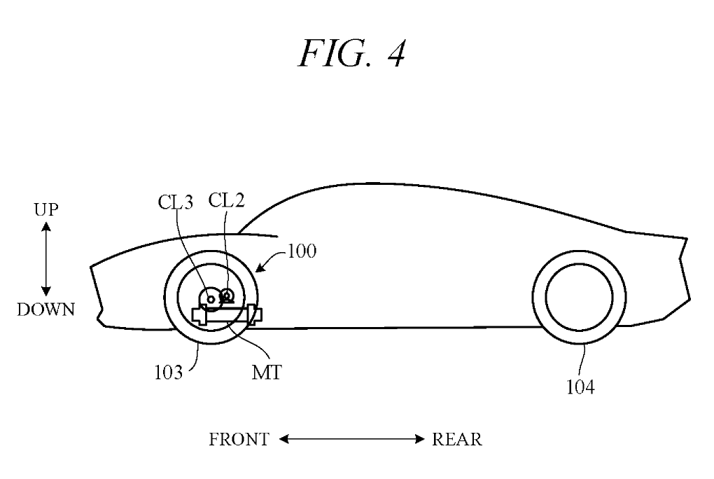

As shown in FIG. 1, the vehicle drive apparatus (vehicle drive unit) 100 includes a first drive unit 101 for converting and outputting torque of the motor MT as torque centered on a lateral axis CL2 and a second drive unit 102 for converting and outputting torque output from the first drive unit 101 as torque centered on a lateral axis CL3. The electric motor MT is also used as a generator. Although the second drive unit 102 appears above the first drive unit 101 in the developed view of FIG. 1, the second drive unit 102 is actually situated forward or rearward of the first drive unit 101, and axis CL3 is located below axis CL2 (see FIG. 4).

As shown in FIG. 1, the vehicle drive apparatus includes the motor MT, a first shaft 1 rotatably supported centered on a vertical axis CL1 extending in up-down direction inside the motor MT, a second shaft 2 rotatably supported centered on the axis CL2 orthogonal to the axis CL1, and a differential 3 rotatably supported centered on the axis CL3 parallel to the axis CL2. Torque from the motor MT is transmitted through the first shaft 1, second shaft 2 and differential 3 to left and right drive shafts 4 and 5, whereby left and right drive wheels are driven.

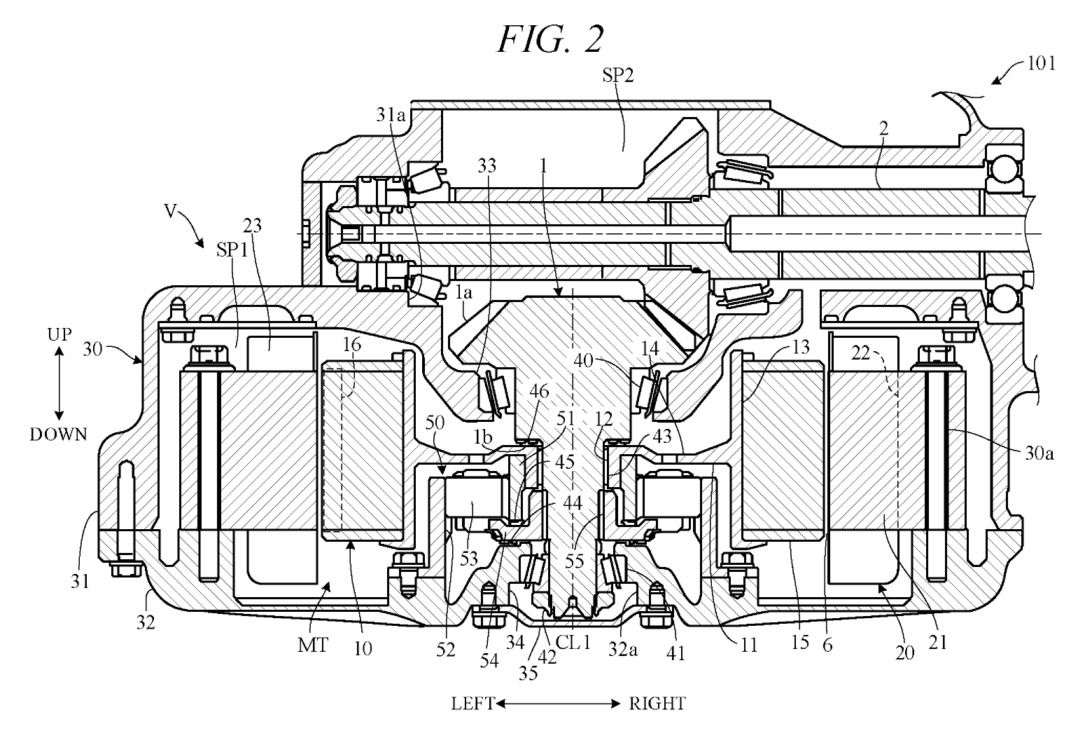

FIG. 2 is an enlarged cross-sectional diagram of main parts of the first drive unit 101 of FIG. 1. As shown in FIG. 2, the motor MT includes a rotor 10 which rotates centered on the axis CL1 and a stator 20 arranged around the rotor 10. The rotor 10 and stator 20 are accommodated in a first housing space SP1 inside a case 30.

The rotor 10 includes a rotor hub 11 and a rotor core 15. The rotor hub 11 includes a substantially cylinder-shaped shaft portion 12 centered on the axis CL1, a cylindrical portion 13 of larger diameter than and coaxial with the shaft portion 12, and a substantially disk-shaped plate portion 14 which extends radially to connect the shaft portion 12 and cylindrical portion 13. The rotor core 15 is a substantially cylinder-shaped rotor iron core centered on the axis CL1. The rotor core 15 is fitted on and fastened to an outer peripheral surface of the cylindrical portion 13 of the rotor hub 11 so as to rotate integrally with the rotor hub 11. The motor MT is an interior permanent magnet synchronous motor, and multiple circumferentially spaced permanent magnets 16 are embedded in the rotor core 15.

The stator 20 has a substantially cylinder-shaped stator core 21 which is centered on the axis CL1 and disposed across a gap 6 of predetermined radial length from an outer peripheral surface of the rotor core 15. The stator core 21 is a fixed iron core whose inner peripheral surface is formed with multiple circumferentially spaced radially outward directed slots 22. A winding 23 (coil) is formed in the slots 22 as a concentrated winding or distributed winding. Upper and lower ends of the winding 23 protrude upward and downward of upper and lower ends of the stator core 21. The rotor 10 rotates when a revolving magnetic field is generated by passing three-phase alternating current through the winding 23.

The case 30 includes an upper case 31 and a lower case 32 which are vertically separable. The stator core 21 is fastened to the lower case 32 by through-bolts 30a. Substantially circular openings 31a and 32a centered on the axis CL1 are formed at a middle region of the upper case 31 and a middle region of the lower case 32, respectively. A shaft support 33 formed in a substantially truncated cone shape is provided in the opening 31a of the upper case 31 to extend downward and radially inward. A shaft support 34 formed in a substantially truncated cone shape is provided in the opening 32a of the lower case 32 to extend upward and radially inward.

Outer peripheral surfaces of the first shaft 1 are respectively rotatably supported by the shaft supports 33 and 34 via taper roller bearings 40 and 41. The first shaft 1 is restrained in axial direction by a nut 42 fastened to its lower end portion. A plate-like cover 35 is attached to a lower surface of the lower case 32 from outside so as to close the opening 32a. An inner peripheral surface of the shaft portion 12 of the rotor hub 11 is supported on the outer peripheral surface of the first shaft 1 via a needle bearing 43 in a manner rotatable relative to the first shaft 1.

A planetary gear mechanism 50 is interposed in a torque transmission path between the rotor 10 and the first shaft 1. The planetary gear mechanism 50 includes a sun gear 51 and a ring gear 52, both of substantially cylinder shape centered on the axis CL1, multiple circumferentially spaced planetary gears 53 disposed between the sun gear 51 and the ring gear 52, and a substantially cylinder shaped carrier 54 rotatably centered on the axis CL1 to rotatably support the planetary gears 53. A needle bearing 44 is interposed between a top surface of the shaft support 34 and a bottom surface of the carrier 54, whereby the carrier 54 is relatively rotatably supported with respect to the shaft support 34. A needle bearing 45 is interposed between a top surface of the carrier 54 and a bottom surface of the sun gear 51, whereby the sun gear 51 is relatively rotatably supported with respect to the carrier 54.

An inner peripheral surface of the sun gear 51 is spline-fitted on an outer peripheral surface of the shaft portion 12 of the rotor hub 11, whereby rotation of the rotor 10 is transmitted to the sun gear 51. The ring gear 52 is fastened on the upper surface of the lower case 32. The planetary gears 53 are engaged with the sun gear 51 and the ring gear 52, whereby rotation of the sun gear 51 is transmitted through the planetary gears 53 to the carrier 54. The carrier 54 has a substantially cylinder-shaped shaft portion 55 centered on the axis CL1. The shaft portion 55 is of smaller diameter than the sun gear 51, and an inner peripheral surface of the shaft portion 55 is spline-fitted on the outer peripheral surface of the first shaft 1 below the needle bearing 43 and above the tapered roller bearing 41, whereby rotation of the carrier 54 is transmitted to the first shaft 1.

A bevel gear 1a of larger diameter than the tapered roller bearing 40 is formed on an upper end portion of the first shaft 1 above the tapered roller bearing 40. A step 1b is provided on the outer peripheral surface of the first shaft 1, whereby the diameter of the outer peripheral surface is reduced below the step 1b. A needle bearing 46 is interposed between a top surface of the plate portion 14 of the rotor hub 11 and a bottom surface of the step 1b, whereby the first shaft 1 is relatively rotatably supported with respect to the rotor hub 11. A second housing space SP2 is formed above the first housing space SP1 inside the upper case 31.

As shown in FIG. 1, the second shaft 2 is rotatably supported on the upper case 31 inside the second housing space SP2 by a pair of left and right tapered roller bearings 61 and 62 installed diagonally left-upward and diagonally right-upward of the bevel gear 1a of the first shaft 1 and by a ball bearing 63 and a roller bearing 64 installed rightward of the tapered roller bearing 62.

The second shaft 2 is inserted along inner peripheral surfaces of a bevel gear 65 and a spacer 66, both of substantially cylinder-shape centered on the axis CL2, which are installed between the left and right tapered roller bearings 61 and 62. At the time of the insertion, the inner peripheral surface of the bevel gear 65 is spline-fitted on an outer peripheral surface of the second shaft 2, whereby the second shaft 2 rotates integrally with the bevel gear 65. Rotation of the first shaft 1 is therefore transmitted through the bevel gears 1a and 65 to the second shaft 2. A spur gear 67 is spline-fitted on the outer peripheral surface of the second shaft 2 between the ball bearing 63 and roller bearing 64, whereby the spur gear 67 rotates integrally with the second shaft 2.

Further, on the left side of the tapered roller bearing 61, an oil guide 68 is fitted on the outer peripheral surface of the second shaft 2. A nut 69 is fastened to the left end portion of the second shaft 2 to restrict the second shaft 2 in the axial direction. At the left end portion of the upper case 31 (a second upper case 31B described later), an opening 31b is formed facing the nut 69. To the left end portion of the upper case 31, a cap 70 is attached to close the opening 31b.

The differential 3 includes a differential case 3a and multiple gears housed in the differential case 3a, i.e., a pair of left and right side gears 3b and 3c respectively attached to the pair of left and right drive shafts 4 and 5, and a pair of pinion gears 3d and 3e which engage the side gears 3b and 3c. An input gear 3f fixed on the differential case 3a engages the spur gear 67 fixed to the second shaft 2, whereby torque of the second shaft 2 is transmitted through the spur gear 67 and input gear 3f to the differential case 3a. Therefore, the differential case 3a rotates around the axis CL3, and the drive shafts 4 and 5 are driven.

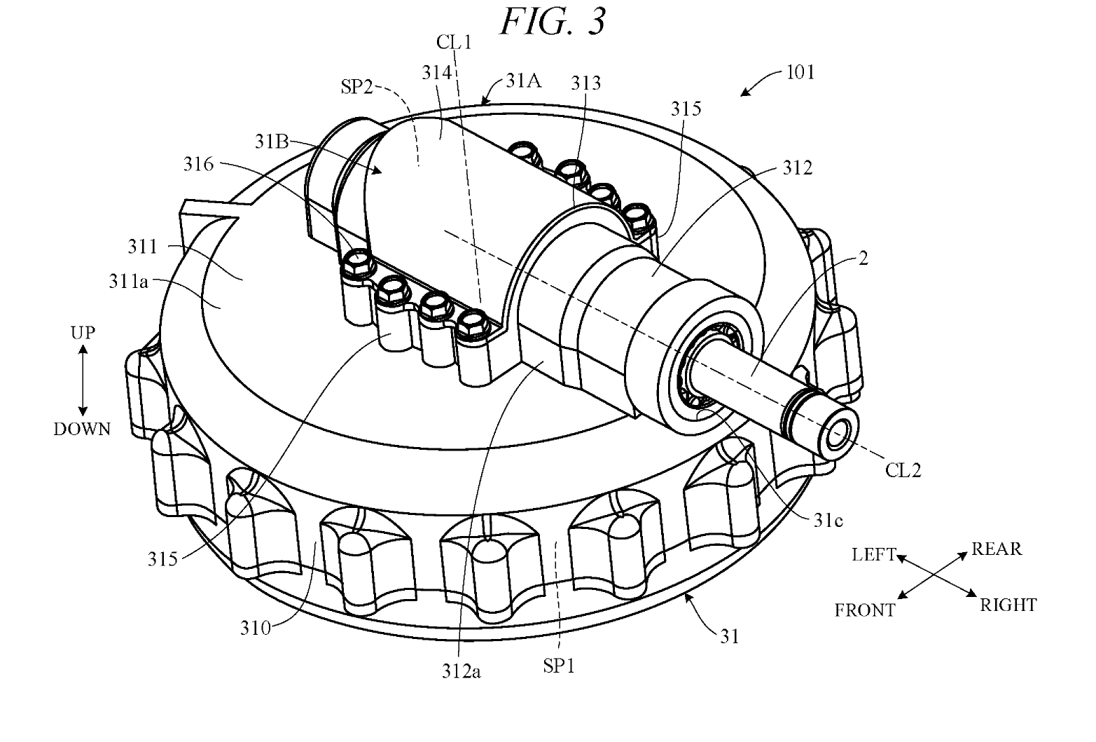

FIG. 3 is a perspective diagram showing part of the first drive unit 101 as viewed obliquely from above. Illustration of the interior of the lower case 32 is omitted in FIG. 3. As shown in FIG. 3, the upper case 31 integrally includes a first upper case 31A which forms the first housing space SP1 (FIG. 2) in cooperation with the lower case 32 and a second upper case 31B provided on top of the first upper case 31A to form the second housing space SP2 (FIG. 2).

The first upper case 31A includes a substantially cylinder-shaped side wall 310 centered on the vertical axis CL1 and a top wall 311 which covers an upper surface of the side wall 310. The second upper case 31B has a swelling portion 312, of roughly cylinder shape centered on the axis CL2 which extends laterally, formed on a top surface 311a of the top wall 311. Wall surfaces 312a of the swelling portion 312 downward of the axis CL2 stand vertically from the top wall 311 in order to form the swelling portion 312 to swell upward from the top wall 311. Therefore, the swelling portion 312 is not strictly cylinder shaped but better described as roughly cylinder shaped or semicylinder shaped.

Diameter of the swelling portion 312 is smaller than that of the side wall 310, and the top surface 311a of the top wall 311 is formed horizontally flat at forward and rearward ends of the swelling portion 312, as well as elsewhere. As shown in FIG. 1, a top surface 1c of the first bevel gear 1a is located below the top surface 311a of the first upper case 31A. The first bevel gear 1a and the second bevel gear 65 engage below the top surface 311a.

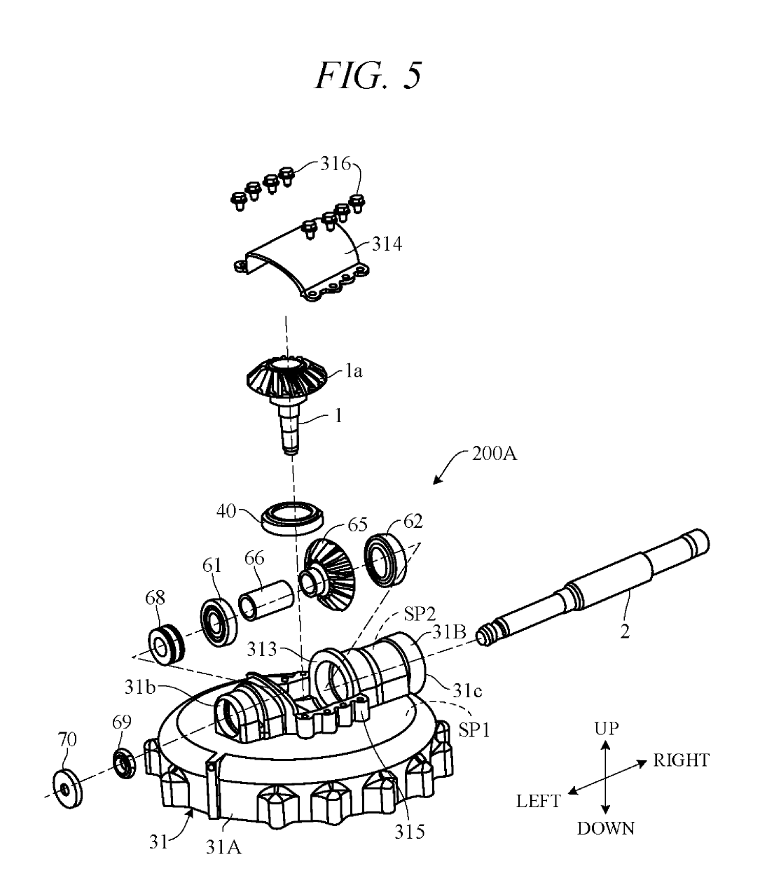

As shown in FIG. 3, an upper surface of the second upper case 31B is provided with a semicylinder-shaped opening 313 centered on the axis CL2 (see FIG. 5), and the axis CL1 passes through the lateral center of the opening 313. The opening 313 is covered by a cover 314 which is a semicylinder-shaped plate. The opening 313 is rectangular in plan view, and the cover 314 is fastened by bolts 316 to mounting bases 315 provided forward and rearward of the opening 313. An opening 31c is provided along the axis CL2 at a right end portion of the second upper case 31B, and a right end portion of the second shaft 2 projects from the opening 31c.

Thus in the present embodiment, the vehicle drive apparatus 100 is configured with the axis of rotation CL1 of the motor MT oriented in vehicle height direction, whereby overall height of the vehicle drive apparatus can be reduced as compared with a vehicle drive apparatus whose axis of rotation CL1 is oriented horizontally. In particular, since the first bevel gear 1a and the second bevel gear 65 are engaged below the top surface 311a of the first upper case 31A, it is possible to suppress minimally a projection length upward of the second upper case 31B. Therefore, a large diameter motor required for developing high output can be easily installed in a height-restricted space of a vehicle.

FIG. 4 is a side view showing an example of installation of the vehicle drive apparatus 100 in the vehicle. In FIG. 4, the vehicle drive apparatus 100 is installed between left and right front wheels 103 for use as a front wheel drive unit. The vehicle drive apparatus 100 can be also installed between left and right rear wheels 104 for use as a rear wheel drive unit.

As shown in FIG. 4, the motor MT is installed below and behind the rotation axis (axis CL3) of the front wheels 103. Therefore, height of the vehicle hood can be lowered to realize enhanced superiority of design and the like. Further, although not illustrated in the drawings, the vehicle drive apparatus 100 can be also easily installed below the vehicle seat or between the left and right rear wheels 104, without raising the floor surface inside the vehicle, and has a high flexibility in the arrangement.

FIG. 5 is an exploded perspective view of components of the vehicle drive apparatus 100 incorporated into the upper case 31. As shown in FIG. 5, the tapered roller bearing 40 and first shaft 1 are inserted from above through the opening 313 into the first housing space SP1 of the first upper case 31A. Next, the oil guide 68, tapered roller bearing 61, spacer 66, bevel gear 65 and tapered roller bearing 62 are inserted through the opening 313 into the second housing space SP2 of the second upper case 31B.

In addition, the second shaft 2 is inserted into the second housing space SP2 through the right end opening 31c of the second upper case 31B. The second shaft 2 passes through the tapered roller bearing 62, second bevel gear 65, spacer 66, tapered roller bearing 61 and oil guide 68, and the nut 69 is fastened to the left end portion of the second shaft 2 via the left end opening 31b of the second upper case 31B, whereafter the cap 70 is attached to a left end portion of the second upper case 31B so as to close the opening 31b. In addition, the cover 314 is attached to the mounting bases 315 of the second upper case 31B by the bolts 316 so as to close the opening 313.

In the aforesaid configuration, the second shaft 2, tapered roller bearings 61 and 62, bevel gear 65, spacer 66 and so on configure a rotor unit 200A used herein as the comparative example of the present embodiment. In the so-configured rotor unit 200A, a certain axial preload needs to be applied to the tapered roller bearings 61 and 62 in axial direction in order to improve runout accuracy and reduce vibration and noise of the second shaft 2. Therefore, in the present embodiment, the rotor unit is configured as set out in the following to enable easy and accurate application of a predetermined preload with respect to the tapered roller bearings 61 and 62.

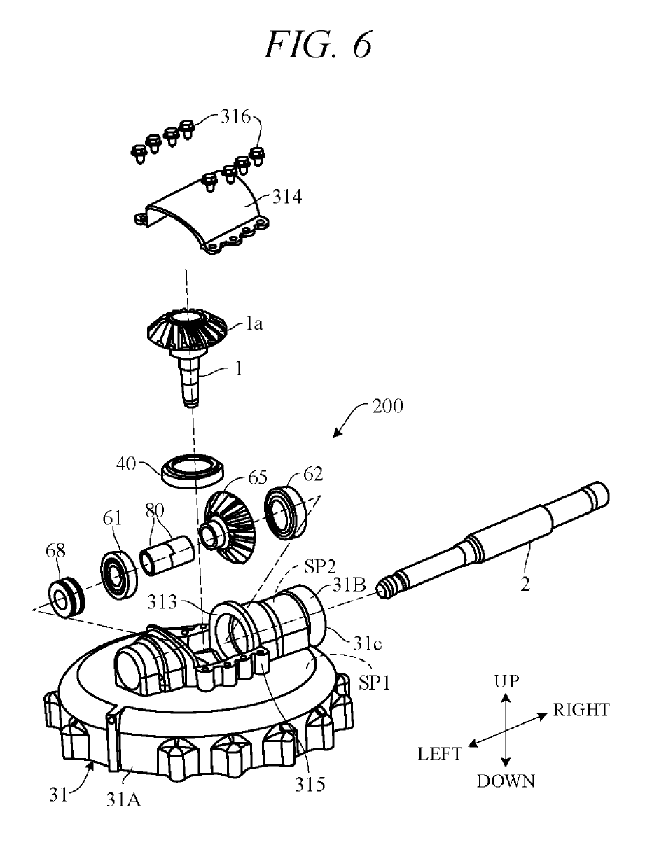

FIG. 6 is an exploded perspective view of main parts of the vehicle drive apparatus 100 including a rotor unit 200 according to an embodiment of the present invention. The rotor unit 200 according to the embodiment of the present invention differs from the rotor unit 200A of the comparative example mainly in the structure of a spacer inserted between the pair of tapered roller bearings 61 and 62. Specifically, the comparative example (FIG. 5) uses the single substantially cylindrical spacer 66, while the present embodiment (FIG. 6) uses an axially (laterally) arranged pair of left and right spacers 80.

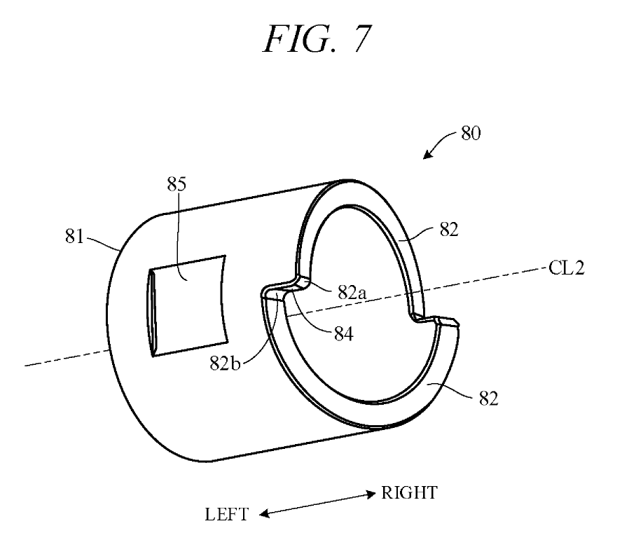

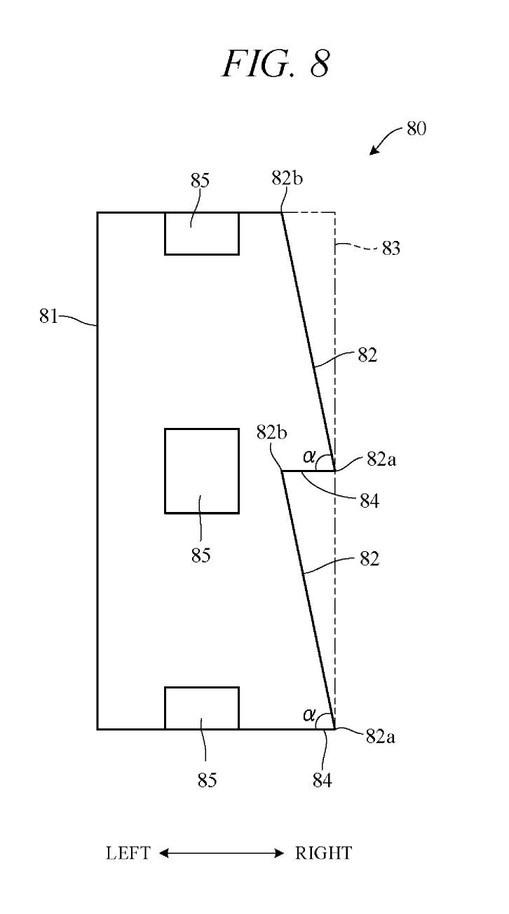

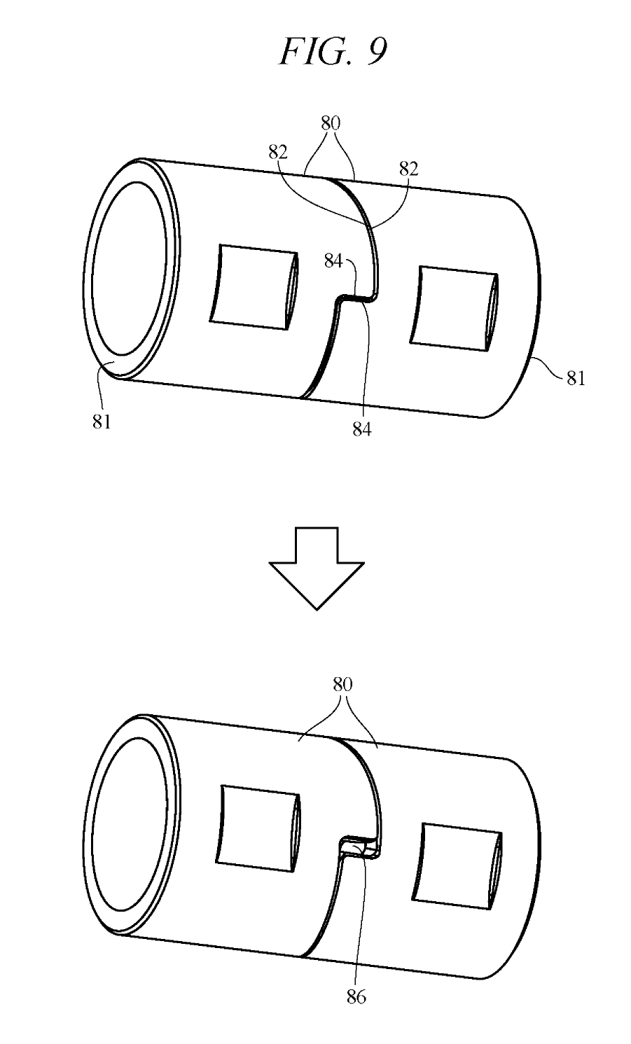

FIG. 7 is a perspective diagram showing a configuration of a left side spacer 80 of the pair of left and right spacers 80 incorporated in the rotor unit 200 according to the embodiment. FIG. 8 is diagram showing the left side spacer 80 in planar developed state. The right side spacer 80 has the same configuration as the left side spacer 80. FIG. 9 is a perspective view showing the pair of spacers 80 in their used condition. In the present embodiment, the pair of identically configured spacers 80 are latterly aligned facing each other in mutually inverted orientation, as shown in FIG. 9.

As shown in FIGS. 7 and 8, the spacer 80 is of substantially cylindrical shape centered on axis CL2, and its one axial end face (left end face) is formed as a flat face 81 perpendicular to axis CL2. Another axial end face (right end face) of the spacer 80 is formed circumferentially with a pair of sloped faces 82 inclined at predetermined angles with respect to a reference plane 83 perpendicular to axis CL2. The sloped faces 82 are formed to be circumferentially symmetrical (in rotational symmetry). More specifically, each sloped face 82 is formed by a flat surface connecting a tip 82a on the reference plane 83 and a base 82b at a position circumferentially 180° apart from the tip 82a and a predetermined distance leftward of the reference plane 83.

In addition the spacer 80 has a pair of end faces 84 connecting same phase tips 82a and sloped faces 82 and extending parallel to axis CL2. Thus the right end portion of the spacer 80 is formed wedge-like by the end faces 84 parallel to axis CL2 and the sloped faces 82. Tip angle a between each sloped face 82 and associated end face 84 is defined as a predetermined angle of less than 90° and greater than, for example, 60°.

Outer peripheral surface of the spacer 80 has a pair of circumferentially spaced cutouts 85 both lying parallel to tangential direction of a circle centered on axis CL2. Distance between the cutouts 85, i.e., distance across flats, is defined a length corresponding to size of a spanner or other tool. A tool can therefore be engaged with the cutouts 85 and used to apply torque centered on axis CL2 to the spacer 80. As a result, as shown in FIG. 9, adjacent spacers 80 and 80 can be slid relatively with their sloped faces 82 kept in mutual contact to produce gaps 86 between end faces 84 and 84 of the adjacent spacers 80 and 80.

Next, a manufacturing method of the first drive unit 101 including the rotor unit 200 according to the embodiment of the present invention is explained. First, with the motor MT and the planetary gear mechanism 50 accommodated beforehand in the first housing space SP1 between the upper case 31 (first upper case 31A) and the lower case 32, the tapered roller bearing 40 is inserted from above through the opening 313 of the upper surface of the second upper case 31B into the first housing space SP1. This tapered roller bearing 40 is fitted in the shaft support 33 of the first upper case 31A (FIG. 2).

Next, the oil guide 68 is inserted through the opening 313 into the second housing space SP2 leftward of the opening 313. The oil guide 68 is inserted with a seal ring fitted on its circumferential surface.

Next, the tapered roller bearings 61 and 62 are inserted through the opening 313 respectively into the second housing space SP2 leftward of the opening 313 and into the second housing space SP2 rightward of the opening 313. The tapered roller bearings 61 and 62 are fitted on inner peripheral surfaces of the substantially cylinder-shaped swelling portion 312, whereby axially outward movement of the outer races is restricted.

Next, the first shaft 1 is inserted from above through the opening 313 into the first housing space SP1. At this time, the outer peripheral surface of the first shaft 1 is fitted on the inner peripheral surfaces of the tapered roller bearings 40 and 41 as shown in FIG. 2, and the outer peripheral surface splines of the first shaft 1 engage the inner peripheral surface splines of the shaft 55 of the planetary gear mechanism 50. Axial position of the first shaft 1 is thereafter restrained by fastening the nut 42 to the lower end portion of the first shaft 1. In this state, the top surface 1c of the first bevel gear 1a is located below the top surface 311a of the first upper case 31A (see FIG. 1).

Next, the pair of left and right spacers 80 is inserted from above through the opening 313 into the second housing space SP2, and the second bevel gear 65 is inserted so as to engage with the first bevel gear 1a. Further, the second shaft 2 is inserted through the right end opening 31c of the second upper case 31B (swelling portion 312) into the second housing space SP2 from the right side. At this time, the second shaft 2 sequentially pass through the tapered roller bearing 62, second bevel gear 65, the pair of spacers 80, tapered roller bearing 61 and oil guide 68, until its left end portion comes to project leftward of the oil guide 68. At the time of the insertion of the second shaft 2, spline formed on the outer peripheral surface of the second shaft 2 is fitted in spline formed on the inner peripheral surface of the second bevel gear 65.

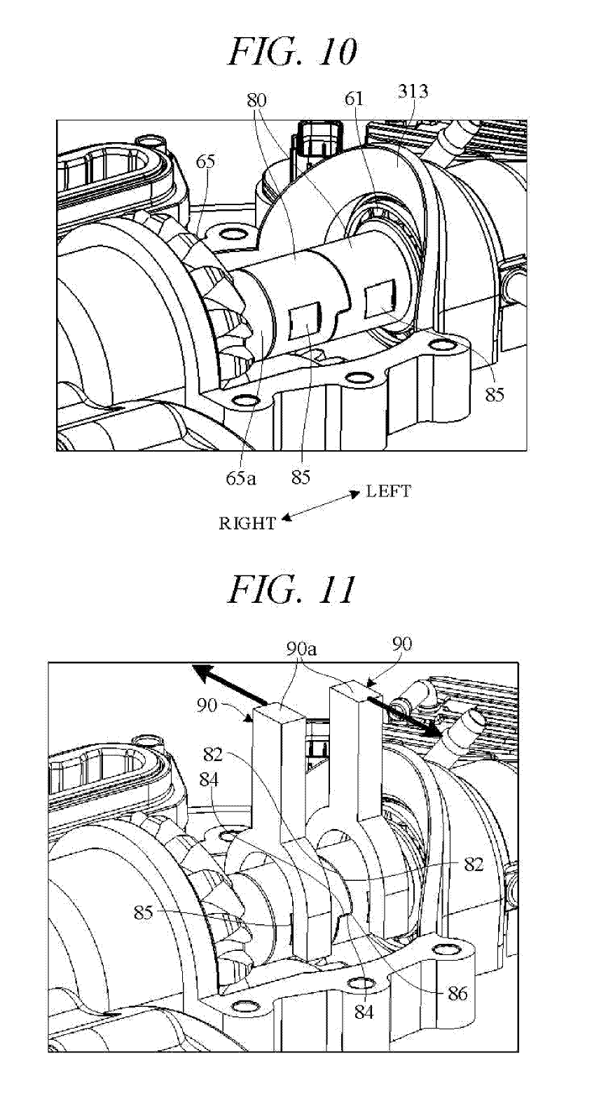

FIG. 10 is a perspective diagram showing arrangement of the pair of spacers 80 at this time. In the state shown in FIG. 10, the flat face (left end face) 81 of the left side spacer 80 abuts an end face of an inner race of the tapered roller bearing 61. Moreover, the flat face (right end face) 81 of the right side spacer 80 abuts a left end face of a shaft 65a of the bevel gear 65, and a right end face of the shaft 65a of the bevel gear 65 abuts an end face of an inner race of the tapered roller bearing 62. No shim for adjusting bearing preload needs to be provided between the shaft 65a of the bevel gear 65 and the tapered roller bearing 62.

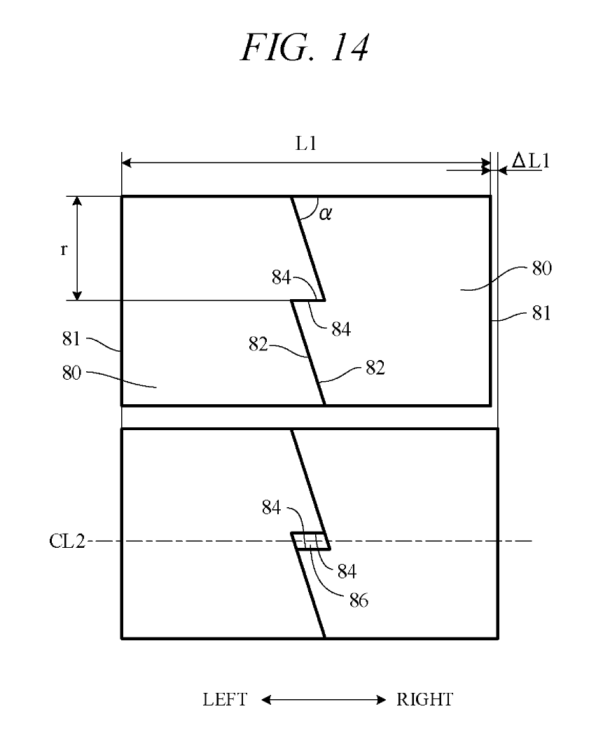

Next, as shown in FIG. 11, generally U-shaped parts of tools 90 are separately engaged with the outer peripheral surface cutouts 85 of the individual spacers 80 and, as indicated by arrows in FIG. 11, torque is applied in opposite directions to distal end portions of arms 90a of the tools 90. For example, the tools 90 are driven in the arrow directions. Alternatively, one of the tools 90 can be maintained stationary and the other tool 90 be driven in its arrow direction. In either case, gaps 86 occur between the end faces 84 and end faces 84 as the sloped faces 82 and 82 of the pair of opposed spacers 80 and 80 slide along each other, whereby distance from one axial end to the other axial end of the pair of spacers 80 and 80 grows longer (see FIG. 14). Therefore, axially outward pushing forces act on the inner races of the pair of tapered roller bearings 61 and 62. As a result, preload can be applied to the tapered roller bearings 61 and 62 from radially inward.

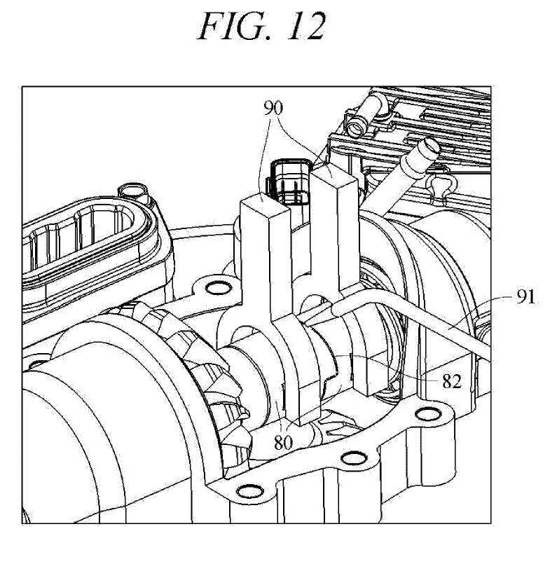

Next, as shown in FIG. 12, a tip of a welding torch 91 is brought close to an abutting region between the sloped faces 82 and 82 of the pair of spacers 80 and 80, and the outer peripheral surfaces of the pair of spacers 80 are welded together. Therefore, since the spacers 80 and 80 are fixed in extended state, preload can be continuously applied to the pair of tapered roller bearings 61 and 62 from their axially inward sides. When welding is finished, the tools 90 are removed. Thus once preload has been applied to the tapered roller bearings 61 and 62 as explained in the foregoing, the tapered roller bearings 61 and 62 are fixed in place. Therefore, as seen in FIG. 6, no nut 69 (FIG. 5) is required at the left end of the second shaft 2 for fastening the tapered roller bearings 61 and 62, so that provision of the opening 31b (FIG. 5) at the left end of the second upper case 31B is also unnecessary.

Finally, the cover 314 is set in place to close the opening 313 of the upper surface of the second upper case 31B from above, whereafter the cover 314 is fastened to the mounting bases 315 of the second upper case 31B by the bolts 316. An assembly of the rotor unit 200 and manufacturing (assembly) of the first drive unit 101 are completed by the foregoing steps.

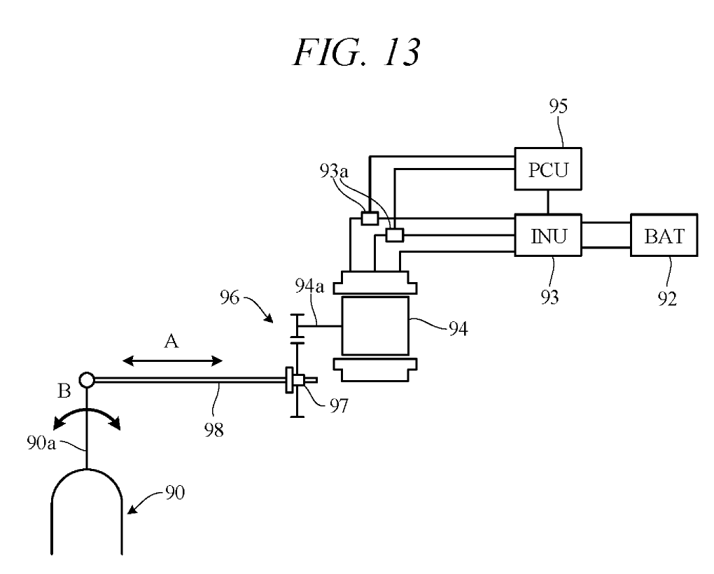

Among the aforesaid fabrication steps, the step of applying torque to the spacers 80 (FIG. 11) can be performed using a bearing preloader. FIG. 13 is diagram schematically illustrating overall configuration of a bearing preloader according to an embodiment of the present invention. As shown in FIG. 13, power from a battery (BAT) 92 is supplied through an inverter (INU) 93 to a motor 94. The inverter 93 is controlled by a power control unit (PCU) 95 based on current value detected by a current sensor 93a, whereby the motor 94 is supplied with predetermined control current.

An output shaft 94a of the motor 94 is rotated by torque proportional to the control current, and the rotation of the output shaft 94a is stepped down by a speed reducer 96 and transmitted to a nut 97. The nut 97 threadedly engages a ball screw 98 and the ball screw 98 moves in arrow A direction in response to rotation of the nut 97. The arm 90a of one of the tools 90 is connected to an end section of the ball screw 98 and the arm 90a is swung in arrow B direction when the ball screw 98 moves in arrow A direction. The resulting rotation of the tool 90 applies torque to the associated spacer 80.

In this case, torque applied to the spacer 80 is adjusted by controlling current supplied to the motor 94. This point is explained below using mathematical expressions. FIG. 14 is a side view of a pair of spacers 80 and 80. The states of the spacers 80 before and after application of torque are shown above and below in FIG. 14. As shown in FIG. 14, when axis CL2-centered torque is applied to the left and right spacers 80 in opposite directions, gaps 86 occur between the end faces 84 and end faces 84 of the left and right spacers 80 and 80, and distance from one axial end (flat face 81) to the other axial end (flat face 81) of the pair of spacers 80 and 80 becomes longer than L1 by ΔL1. Where radius of the spacers 80 is designated as “r” and rotation angle of the arm 90a as “θ” at this time, axial strain “ε” of the spacers as a whole is expressed by the following Equation (I):

ε=ΔL1/L1=r·θ/(L1·tan(α)) (I)

Based on relation between stress σ acting on end face of spacer 80 (flat face 81) and strain ε, the following Equation (II) can be derived from Equation (I):

σ=Eε=E·r θ/(L1·tan(α)) (II)

Where a speed-reducing ratio of the speed reducer 96 is designated “N”, torque constant of the motor 94 as “KI”, supply current of the motor 94 as “I”, length of arm 90a as “L2”, and cross-sectional area of spacer 80 as “A”, a relation between torque of the motor 94 and stress acting on spacer 80 is expressed by Equation (III):

N·Ki·I/L2=A·σ (III)

Substituting Equation (II) into σ of Equation (III) gives Equation (IV):

I=E·A·L2·r·θ/(N·Ki·L1·tan(α)) (IV)

The power control unit 95 performs the aforesaid computations and controls the inverter 93 so as to supply predetermined supply current I to the motor 94. Predetermined preload can therefore be easily and accurately applied to the tapered roller bearings 61 and 62.

According to the embodiment, the following operations and effects can be achieved.

(1) The rotor unit 200 according to the embodiment of the present invention includes the second shaft 2 extending along axis CL2, the pair of tapered roller bearings 61 and 62 for rotatably supporting the second shaft 2, and the pair of substantially cylindrical spacers 80 and 80 axially aligned between the pair of tapered roller bearings 61 and 62 coaxially with the second shaft 2 to surround the second shaft 2 (FIGS. 1 and 6). The pair of spacers 80 and 80 have the sloped faces 82 and 82 inclined with respect to the reference plane 83 perpendicular to axis CL2 and installed in abutment with each other, and these sloped faces 82 and 82 are welded to each other in a state with length L1 from one axial end to the other axial end of the pair of spacers 80 extended by axis CL2-centered torque applied to the pair of spacers 80 and 80 in opposite directions (FIGS. 6 to 9, FIG. 12 and FIG. 14).

Owing to this structure, the tapered roller bearings 61 and 62 rotatably supporting the second shaft 2 can be applied with appropriate preload from axially inward, with no need to rely on fastening force arising when the cases are bolted together. Moreover, a shim for adjusting preload can be omitted because preload is applied to the tapered roller bearings 61 and 62 in accordance with a rotation amount of spacer 80. In addition, preload pressure can be accurately adjusted by adjusting a rotation amount of spacer 80.

(2) The rotor unit 200 further includes the second upper case 31B that supports the outer peripheral surfaces (outer races) of the tapered roller bearings 61 and 62 and has the opening 313 for exposing the spacers 80, and the cover 314 for closing the opening 313 (FIG. 6). Therefore, once the rotor unit 200 is assembled, rotation of the tools 90 engaged with the spacers 80 and the spacers 80 can easily exert preload to the tapered roller bearings 61 and 62.

(3) The rotor unit 200 further includes the bevel gear 65 provided integrally rotatable with the second shaft 2 and installed between the pair of tapered roller bearings 61 and 62 and adjacent to the spacers 80 in the axial direction (FIGS. 5 and 9). Even in the rotor unit 200 incorporating the bevel gear 65 in this manner, necessary and sufficient preload can be applied to the tapered roller bearings 61 and 62 by rotating the pair of spacers 80 in opposite directions with each other around axis CL2.

(4) The outer peripheral surface of each of the spacers 80 and 80 has the cutouts 85 formed to have width across flats corresponding to tool size (FIG. 6). Therefore, since tools can be engaged with the spacers 80, large torque can be applied to the spacers 80 as required for establishing preload.

(5) The manufacturing method of the rotor unit according to the embodiment of the present invention includes: arranging the pair of tapered roller bearings 61 and 62 through the opening 313 to be centered on axis CL2 inside the second upper case 31B; arranging the pair of substantially cylindrical spacers 80 and 80 to be centered on axis CL2, i.e., the pair of spacers 80 and 80 each having the sloped faces 82 inclined with respect to the reference plane 83 perpendicular to axis CL2, along axis CL2 through the opening 313 between the pair of tapered roller bearings 61 and 62 to be centered on axis CL2 in a state with their sloped faces 82 abutting each other; inserting the second shaft 2 along axis CL2 to inside the pair of tapered roller bearings 61 and 62 and inside the pair of spacers 80 and 80; applying torque to the pair of spacers 80 and 80 in opposite directions around axis CL2 to extend length L1 from one axial end to the other axial end of the pair of spacers 80 and 80; and welding the sloped faces 82 of the pair of spacers 80 to each other in a state with length from one axial end to the other axial end of the pair of spacers 80 and 80 extended (FIGS. 10 to 12). This enables application of appropriate preload to the tapered roller bearings 61 and 62 rotatably supporting the second shaft 2.

In the above embodiment, the pair of spacers 80 and 80 having the sloped faces 82 inclined with respect to the reference plane 83 and the end faces 84 extending parallel to axis CL2 are provided. However, for example, the end faces 84 can instead be inclined with respect to axis CL2. Moreover, the pair of spacers have sloped faces at only one circumferential position or at three or more circumferential positons, instead of at two circumferential positions as in the above embodiment. Therefore, the pair of spacers are not limited to the above configuration.

In the above embodiment, the rotor unit 200 is configured to apply preload to a pair of tapered roller bearings (61 and 62). However, the bearings are not limited to this type and a rotor unit using another type of bearings, such as angular contact bearings, is also possible. In the above embodiment, the bevel gear 65 is provided on the second shaft 2 to rotate integrally therewith. However, the rotating shaft is not limited to the aforesaid structure and can optionally include other gears or the like. In the above embodiment, the tapered roller bearings 61 and 62 are accommodated in the second upper case 31B formed with the opening 313. However, the case for supporting the outer peripheral surfaces of the bearings is not limited to this configuration. The cover for closing the opening of the case is also not limited to the above one (cover 314). In the above embodiment, the cutouts 85 matched to the size of tools are formed in the outer peripheral surfaces of the spacers 80. However, the configuration of the cutouts can be suitably modified in accordance with size and shape of tool.

In the above embodiment, the rotor unit 200 is applied to the vehicle drive apparatus 100. However, the rotor unit of the present invention can also be similarly applied to any of various apparatuses other than a vehicle drive apparatus.

The above embodiment can be combined as desired with one or more of the above modifications. The modifications can also be combined with one another.

According to the present invention, bearings rotatably supporting a rotating shaft can be applied with appropriate preload, with no need to rely on fastening force arising when cases are bolted together.

Above, while the present invention has been described with reference to the preferred embodiments thereof, it will be understood, by those skilled in the art, that various changes and modifications may be made thereto without departing from the scope of the appended claims.

What is claimed is:

1. A rotor unit, comprising:
a rotating shaft extended in an axial direction along an axial line;
a pair of bearings configured to rotatably support the rotating shaft; and
a pair of spacers arranged adjacent to each other between the pair of bearings and coaxially with the rotating shaft and formed in substantially cylindrical shapes to surround the rotating shaft, wherein
the pair of spacers include first ends facing each other and second ends opposite to the first ends in the axial direction, respectively,
the first ends include sloped faces inclined with respect to reference planes perpendicular to the axial line, and
the sloped faces are configured to abut to each other and be welded to each other in a state that a length between the second ends of the pair of spacers in the axial direction is extended by torque applied to the pair of spacers in opposite directions with each other around the axial line.

2. The rotor unit according to claim 1, wherein
the first ends include a plurality of the sloped faces in a circumferential direction and an axial face extended parallel to the axial line between the plurality of the sloped faces, respectively,
the pair of spacers are a first spacer and a second spacer, and
the axial face of the first spacer and the axial face of the second spacer is configured to separate from each other in the state.

3. The rotor unit according to claim 1, wherein the second ends include flat faces perpendicular to the axial line.

4. The rotor unit according to claim 1, further comprising:
a case configured to support outer peripheral surfaces of the pair of bearings and including an opening formed to expose the pair of spacers; and
a cover configured to close the opening.

5. The rotor unit according to claim 1, further comprising a bevel gear arranged between the pair of bearings and adjacent to the pair of spacers in the axial direction to rotate integrally with the rotating shaft.

6. The rotor unit according to claim 1, wherein
the pair of spacers include cutouts with width across flats corresponding to a size of a tool.

7. A manufacturing method of a rotor unit, comprising:
arranging a pair of bearings along an axial line through an opening formed in a case inside the case;
arranging a pair of spacers formed in substantially cylindrical shapes centered on the axial line and including sloped faces inclined with respect to reference planes perpendicular to the axial line, along the axial line through the opening between the pair of bearings in a state with the sloped faces abutting each other;
inserting a rotating shaft along the axial line to inside the pair of bearings and inside the pair of spacers;
applying torque to the pair of spacers in opposite directions with each other around the axial line to extend a length from one end to the other end of the pair of spacers in the axial direction; and
welding the sloped faces of the pair of spacers to each other in a state with the length extended.
